(19) United States
(12) Patent Application Publication
(10) Pub. No.: US 2004/0101747 A1
(43) Pub. Date: May 27, 2004

(54) Method and apparatus for detecting the presence of rechargeable batteries

(76) Inventors: William C. Bushong, Madison, WI (US); Larry J. Kundert, Fort Atkinson, WI (US); Janna L. Rose, Oregon, WI (US)

Correspondence Address: QUARLES & BRADY LLP, 411 E. WISCONSIN AVENUE, SUITE 2040, MILWAUKEE, WI, 53202-4497, US

(21) Appl. No.: 10/631,235

(22) Filed: Jul. 31, 2003

Related U.S. Application Data
(60) Provisional application No. 60/399,881, filed on Jul. 31, 2002.

(51) Int. Cl. H01M 2/02; H02J 7/00

(52) U.S. Cl. 429/163; 429/176; 320/107

(57) ABSTRACT

A method and apparatus are disclosed for automatically detecting the presence of a secondary cell and additionally differentiating between various types of secondary cells within the charger. Certain secondary cells include a band of ink that surrounds the cells and has a predetermined resistance that is detectable via charger contacts to identify the charging capability. The cell is detected using a pair of contacts that engage the outer surface of the cell at a predetermined location. The charger applies a charge to the cell that varies based on the sensed cell type.

### CROSS-REFERENCE TO RELATED APPLICATIONS

The present application claims priority to U.S. Provisional patent application No. 60/399,881, filed Jul. 31, 2002 and entitled “Method and Apparatus for Detecting the Presence of Rechargeable Batteries” the disclosure of which is hereby incorporated by reference as if set forth in its entirety herein.

### STATEMENT REGARDING FEDERALLY SPONSORED RESEARCH OR DEVELOPMENT

### BACKGROUND OF THE INVENTION

The present invention relates to electrochemical cells, and in particular, relates to a method and apparatus for automatically determining the presence of a rechargeable cell and discriminating between cell types.

The vast majority of portable electronic devices can be battery operated. The battery or batteries required to operate such devices are typically inserted into an internal cavity or are attached to an external surface of the device. These devices historically relied upon power provided by primary cells that had to be discarded once depleted. Secondary cells, such as nickel-cadmium, were subsequently developed for use with battery-operated devices that could be depleted and recharged for further use. Nickel-metal hydride, lithium ion, and rechargeable alkaline manganese cells have since been introduced as an alternative to nickel-cadmium cells.

Some devices have automatic charging capabilities. For example, a cellular telephone batteries can be charged simply by plugging the telephone directly into an electrical outlet, thus eliminating the need to first remove the batteries from the device. Other devices require that the user remove the rechargeable batteries and recharge them using an external charging device. In order to maintain the interchangeability with primary cells in the battery-operated device, secondary cells have been constructed to be of the same size and shape of their primary counterparts. The risk thus exists that a user may unknowingly place a primary cell into a charging device while mistaking the cell for a secondary cell. When a charging current and/or voltage is applied to a primary cell, heat and pressure can accumulate that can cause the cell to fail in an unpredictable manner.

Furthermore, secondary cells are being introduced that have varying charging capacities. Some of these cells (fast charging cells) are able to accept higher charging currents and voltages than others (slow charging cells) without succumbing to damaging elevated internal pressure.

It is thus desirable to produce secondary cells having identifying indicia recognizable to a charging device to prevent the charging of a primary cell. It is further desirable that the charger identify various properties among identified secondary cells, and apply a charging current or voltage accordingly.

### BRIEF SUMMARY OF THE INVENTION

The present invention discloses a cell charging system that includes a secondary cell having a positive and negative terminal end and a band of resistive media surrounding at least a portion of the outer surface of the cell. A charger has a first pair of contacts suitable to engage the positive and the negative terminal ends of the cell, and a second pair of contacts to detect the presence of the band. The charger automatically delivers a charge to the cell only when the band is detected.

This and other aspects of the invention are not intended to define the scope of the invention for which purpose claims are provided. In the following description, reference is made to the accompanying drawings, which form a part hereof, and in which there is shown by way of illustration, and not limitation, preferred embodiments of the invention. Such embodiments do not define the scope of the invention and reference must be made therefore to the claims for this purpose.

### BRIEF DESCRIPTION OF THE DRAWINGS

Reference is hereby made to the following figures in which like reference numerals correspond to like elements throughout, and in which:

FIG. 1 is a an electrochemical cell incorporating a resistive band constructed in accordance with the preferred embodiment of the invention;

FIG. 2A is a sectional side elevation view of a pressure-responsive switch installed in the cell illustrated in FIG. 1, wherein the switch is in a closed position;

FIG. 2B is a sectional side elevation view of the switch illustrated in FIG. 2A, wherein the switch is in an open position;

FIG. 4 is a partial sectional side elevation view of the cell illustrated in FIG. 1;

FIG. 5 is a perspective view of a cell charger constructed in accordance with the preferred embodiment;

FIG. 6 is a top perspective view of the charger illustrated in FIG. 5;

FIG. 7 is a top perspective view of a charger constructed in accordance with an alternate embodiment of the invention;

FIG. 8 is a fragmented sectional side elevation view of the charger illustrated in FIGS. 5 and 6;

FIG. 9 is a fragmented sectional side elevation view of the charger illustrated in FIG. 8 with a size AA cell installed;

FIG. 10 is a fragmented sectional side elevation view of the charger illustrated in FIG. 8 with a size AAA cell installed;

FIG. 11 is an exploded perspective view of resistance sense contacts and a voltage detection switch constructed in accordance with the preferred embodiment;

FIG. 12 is a side elevation view of the voltage detection switch illustrated taken along line 12-12 of FIG. 10;

FIG. 13 is a side elevation view of the resistance sense contacts illustrated in FIG. 11;

FIG. 14 is an end elevation view of a charging compartment of the charger taken along line 14-14 of FIG. 10;

FIG. 15 is a sectional end elevation view taken along line 15-15 of FIG. 10, illustrating the resistance sense contacts;

FIG. 16 is a schematic sectional side elevation view of a battery charging assembly constructed in accordance with an alternate embodiment of the invention;

FIG. 17 is a perspective view of a portion of a cradle used to support a battery that is disposed within charger illustrated in FIG. 16;

FIG. 18 is a schematic view of four cells being charged in parallel in accordance with the preferred embodiment;

FIG. 19 is a flowchart illustrating a cell charging routine in accordance with the preferred embodiment; and

FIG. 20 is a schematic view of a divider circuit used to detect cell band resistance in accordance with the preferred embodiment.

### DETAILED DESCRIPTION OF THE PREFERRED EMBODIMENT

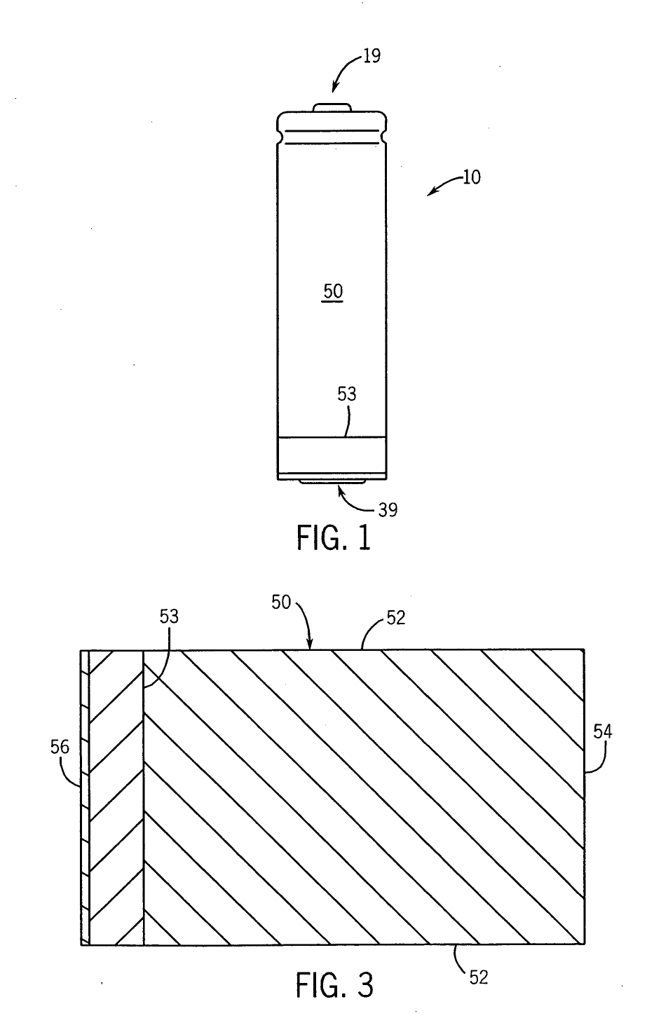

Referring to FIG. 1, a size AA nickel-metal hydride rechargeable cell 10 has a positive terminal end 19 and a negative terminal end 39. Cell 10 is configured to accept high charging currents compared to conventional secondary cells, as will become apparent from the description below. It should be appreciated, however, that the present invention is equally applicable to rechargeable nickel-based cell, alkaline metal cell, rechargeable lithium cell, rechargeable lead acid cell, or any other secondary electrochemical cell. Furthermore, while a size AA cell is illustrated, it should be appreciated that the present invention is equally applicable to other cell sizes, for example, size AAA, C, and D cells.

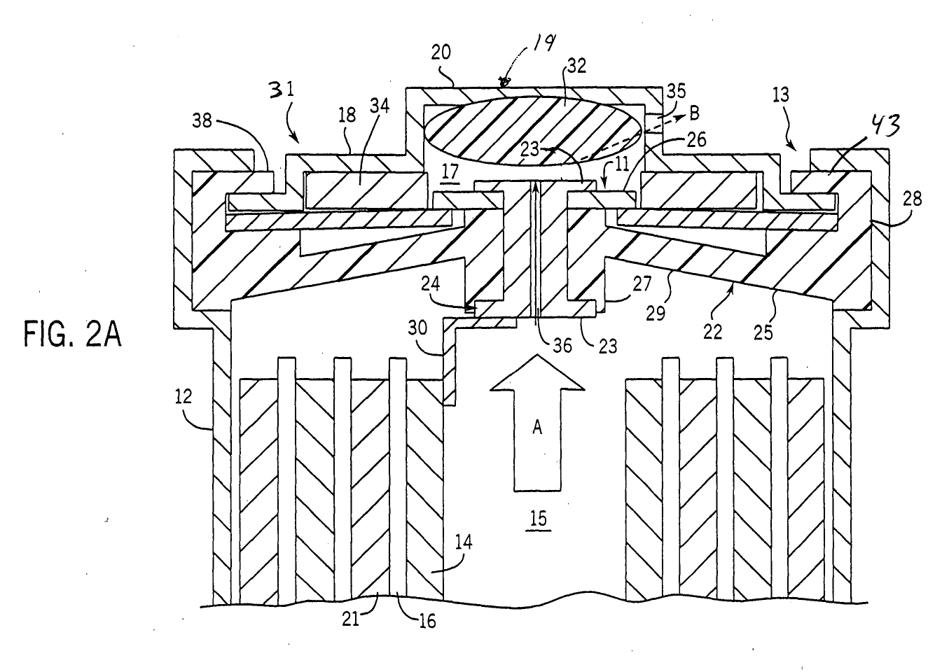

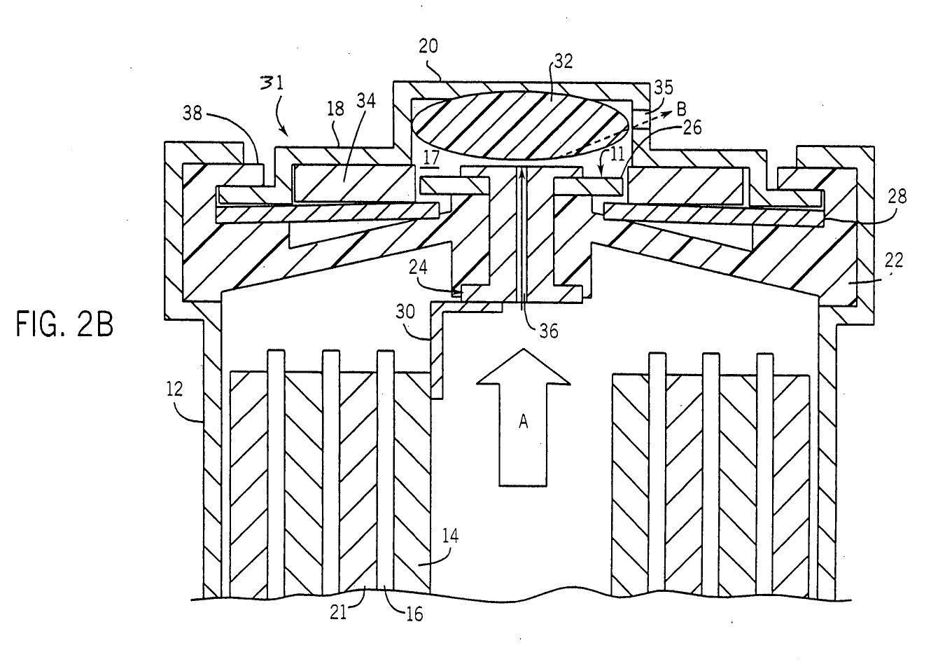

Referring now to FIG. 2A, axially extending cell 10 includes a can 12 having closed end (not shown) and an open end 13 disposed opposite the open end and axially downstream therefrom. A cap assembly 31 includes a positive terminal end cap 18 that is secured in the open end of the negative can 12 to provide closure to the cell. In particular, the end cap assembly 31 and the open end of the can 12 are adapted in size and shape such that the end cap assembly 31 is sealingly accommodated in the open end by crimping the negative end of can 12 during assembly of a cylindrical rechargeable metal hydride cell. The closed end of the can is conventional and is not shown.

Cell 10 includes a pressure-responsive switch 11 that places positive (e.g., nickel hydroxide) electrode 14 in removable electrical connection with the positive terminal cap 18. The negative electrode 21 (e.g., hydride electrode) is in electrical connection with the can 12, and an alkaline electrolyte (e.g., potassium hydroxide) alone or in combination with other alkali metal hydroxides. The electrodes are disposed in an internal cavity 15, and are separated by a separator 16. A cell comprising the can 12 and the end cap assembly 31 of the invention can further comprise conventional positive 14 and negative 21 wound electrodes in its interior, although the relative size of these electrodes can be adjusted to meet the physical and electrical specifications of the cell.

The positive terminal cap 18 has a nipple 20 that is sized and shaped to provide a positive terminal to the cell 10. The pressure-responsive switch 11 comprises a flexible non-conductive mono-stable member in the form of a grommet 22 adapted in size and shape to fit securely in the open end 13. Grommet includes a radially outer seal 25, an inner hub 27, and an arm 29 that extends substantially radially and connects the seal to the hub. Grommet 22 further includes has a centrally disposed opening 15 extending axially through the hub 27 in which is seated a conductive spool-shaped connector 24 having a pair of oppositely disposed radially extending outer flanges 23. The space between the outer surface of grommet 22 and inner surface of terminal end cap 18 defines a cavity 17 in the end cap assembly 31.

Connector 24 is securely fixed in the opening of grommet 22 such that the conductive connector moves in concert with the grommet. A first annular conductive contact 26, which is a metal washer in accordance with the illustrated embodiment, surrounds the hub of connector 24 and has an upper surface in electrical contact with the upper flange 23. A second annular conductive contact 28 (which can also be a metal washer) surrounds the grommet and is positioned axially upstream and adjacent the first contact 26. The first and second contacts 26, 28 are circular plates in FIG. 2A but they can be provided in other shapes, as appreciated by one having ordinary skill in the art. Contact 28 has an upper surface 43 that is in electrical connection with the terminal cap, and in removable mechanical (and therefore electrical) connection with the bottom surface of the first contact 26.

The grommet 22 can be formed of any sufficiently flexible, nonconductive inert material that does not adversely impact the cell chemistry. Suitable materials include but are not limited to polypropylene, polyolefin and nylon and their equivalents.

The outer seal 25 of grommet 22 includes an upwardly and radially inwardly extending peripheral lip 38 that is shaped and sized to form a tight seal with the open end of the can to provide a barrier between the interior and the exterior of the cell. The lip 38 also partially defines a cavity in the outer seal 25 in which the outer end of terminal end cap 18 and second contact 28 are disposed. The lip 38 presents a radially outer convex surface to permit the can 12 to be crimped over the grommet 22 during assembly of the cell. When the axially downstream end of can 12 is crimped over the grommet 22 during assembly, a tight seal is provided between the grommet 22, second contact 28, and terminal end cap 18 to isolate the interior of the cell from the ambient environment. An optional sealant such as asphalt or tar can also be employed between the end cap assembly 31 and the can 12 to strengthen the seal.

A flexible conductive tab 30 electrically connects the conductive connector 24 to the positive electrode 14 in the interior of the cell. The conductive connector 24 can be an eyelet or rivet that is secured in the central opening by crimping at its ends to provide flanges 23 that secure the hub 27 of grommet 22 and the first contact 26. The conductive connector 24 is in electrical and physical contact with the first contact 26 thereby helping to secure the conductive connector 24 into position.

FIG. 2A illustrates the end cap assembly in a low pressure state, such that the grommet 22 is in its stable position. In this low pressure state, the positive electrodes 14 are in electrical connection with the positive terminal cap 18 via the conductive tab 30, connector 24, first contact 26, and second contact 28. Accordingly, the cell may be charged by introducing a recharging current or voltage to the cell. Advantageously, when internal pressure within the cell accumulates beyond a predetermined threshold, the grommet 22 flexes (reversibly) axially downstream along the direction of arrow A to bias the pressure-responsive from the first position illustrated in FIG. 2A to a second position illustrated in FIG. 2B. It should be appreciated that the predetermined threshold may depend on the intended type of charge being used (e.g. constant current, constant voltage, etc. . . ), and may be determined by the material selected for the grommet, and thickness and flexibility of the arm 29.

Referring now to FIG. 2B, when the internal pressure within the cell exceeds the predetermined threshold sufficient to flex the grommet 22, the hub 27 is translated axially downstream, thereby also translating the first contact axially downstream with respect from the second contact 28, and removing the electrical connection therebetween. As a result of the switch 11 opening, an electrical connection at the nipple 20 will not transfer to the electrodes 14 within the cell, and further charging is prevented until the overpressure situation subsides and the switch closes, at which point charging can continue.

Optionally, an insulating overpressure stop 32 can also be provided in an interior cavity defined by the nipple 20. The overpressure stop 32 can also be used to pre-load the contact pressure as desired and can limit motion of the conductive connector 24 in the direction of the nipple 20 when internal cell pressure is high. A stop washer 34 can also optionally be disposed between the second contact 28 and terminal end cap 18 to restrain the movement of the second contact when the grommet 22 flexes, thereby further insuring that the electrical connection will be severed between the two contacts during a high pressure state.

FIGS. 2A-B also illustrate an optional safety system for venting excess pressure (gas) from the cell when in an overpressure condition. In particular, the conductive connector 24 can define a centrally disposed pressure release channel 36 extending axially therethrough. Accordingly, gas produced at the electrodes is able to flow axially downstream from the cell interior 15 and through channel 36 to end cap interior 17. The end cap 18 also defines one or more outlets 35 extending therethrough to enable the gas to flow from the end cap assembly 31 to the outside environment. The outlet can be secured against undesired leakage with a seal (not shown) adapted in tensile strength to yield at a pre-selected pressure level to release gas from the cell. The seal can be reversible or irreversible.

Alternatively, outlet(s) 35 may be permanently open to the environment, in which case a reversible airtight seal to the interior of the cell is maintained by blocking the pressure release channel 36. In particular, the overpressure stop 32 can also function as a overpressure release control if it is formed of a suitably deformable plastic material such as rubber for sealing pressure release channel 36 and outlet(s) 35 (if not open to the environment). In addition to the deformable material shown, other structures for releaseably blocking the pressure release channel include, without limitation, a plug or a spring. When the internal cell pressure rises to a sufficiently high level, the block is urged away from channel 36 and from outlet(s) 35 to define a pressure release path from the cell interior to the outside environment. The pressure at which the vent system releases the cell internal pressure depends on how much internal pressure a battery can withstand; the plastic material of the overpressure stop 32 is selected to respond to a pressure at which venting is desired, but to remain securely in place at lower pressures. Generally speaking, for a metal hydride rechargeable cell, the safety vent system responds to cell internal pressures of about 600 psig and higher, more typically in the range of between about 1000 to 1200 psig.

The opening and closing of the pressure release path through channel 36 and outlet(s) 35 can be reversible but may also be made irreversible by employing a block made of materials that do not revert to a shape or size or position that can effectively block the pressure release path after a first pressure rise. It will be appreciated that blocks other than those disclosed herein can be employed in both reversible and irreversible vent systems.

It should thus be appreciated that cell 10 is capable of receiving charge currents that are higher than charge currents currently available to conventional secondary cells without failing due to excessive internal cell pressure buildup. It would thus be desirable to automatically sense and differentiate cell 10 from other secondary cells in a charger to apply the appropriate charging current based on the sensed cell type.

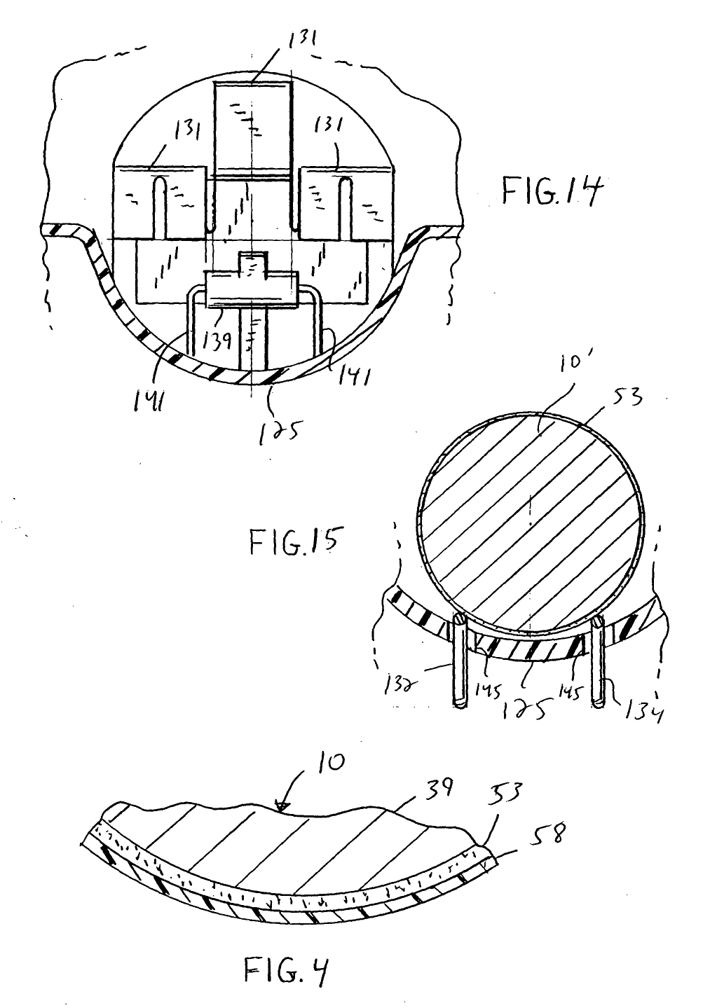

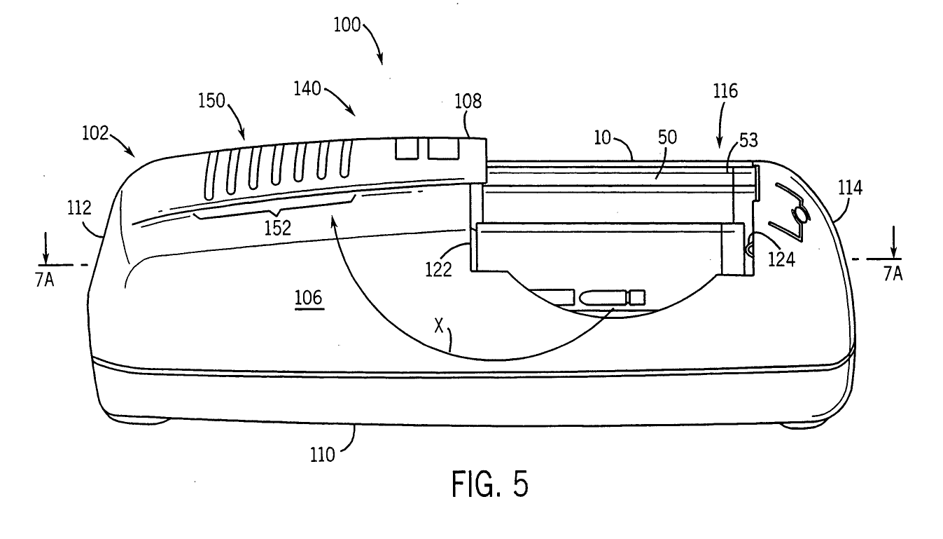

Accordingly, referring now to FIGS. 1 and 3 in particular, the outer periphery of the battery 20 is surrounded by a label 50 that carries cell identifying indicia that can be sensed by a cell charger 100 (See FIG. 5). Label 50 is rectangular or square in overall shape, and includes a pair of opposing longitudinally extending edges 52. Edges 52 are connected to a first laterally extending edge 54, and an opposing laterally extending edge 56. Label 50 is installed onto the outer surface of the cell can 12 by bringing longitudinal edges 52 together (possibly overlapping) to form an annulus. Label is oriented such that lateral edge 54 is disposed proximal the positive end 19 of the cell 10, and lateral edge 56 is disposed proximal the negative end 39 of the cell 10.

Label 50 is electrically insulating, and thus has a resistance within the range of 500 KΩ and 1 MΩ or greater, which is typical of conventional cell labels. A band 53 extends between opposing longitudinal edges 52 and is disposed proximal laterally extending edge 56. Band 53 is preferably offset slightly from lateral edge 56, and is approximately 5 mm wide in the longitudinal direction. Band 53 preferably comprises a conductive carbon ink that is applied to label 50 using a rotogravure process, or flexographically printed directly onto the label 50. Accordingly, when the label 50 is wrapped into an annulus and installed onto the periphery of the cell can, the band is disposed proximal the negative end 39 of cell 10. Band 53 has a resistance within a predetermined range, and is positioned at a predetermined location relative to the negative cell terminal 39 to enable charger 100 to detect the presence of band 53 and measure the resistance of the band identifying the cell 10 as suitable to accept a particular charging current. The resistance of ink 28 may furthermore identify the cell size, chemistry, type, and/or capacity.

It should be appreciated that band 53 could be disposed essentially anywhere on the battery 10, for example proximal the positive terminal end 19 or anywhere between the terminal ends 19 and 39. The negative terminal end 39 is preferred for several reasons. First, there is typically a housing component and contacts into a circuit board in close proximity. Secondly, the large surface area in the middle of the cell 10 can be left open for unrestricted to air flow thereby more quickly cooling the cell 10 and thus more rapidly and completely charging it. Furthermore, the label 50 at the negative end of the cell does not shrink around the cell end during manufacturing, which thereby removes the processing and cosmetic difficulties of shrinking the externally printed label 53 around a cell end. Finally, when the battery 10 is placed in packages in a side-by-side configuration, the negative ends of the cells 10 have the smallest probability of colliding and subjecting the band 53 to abrasion.

The band 53 has a resistance greater than that of the metal container 12, and less than that of the label 50 so as to be identifiable to the charger 100. In one embodiment, the charger determines that the resistance of band 53 is within a predetermined range, thereby indicating the presence of a secondary cell. Furthermore, several types bands may be manufactured, each having a predetermined and unique resistance. The unique resistance levels are specific to a given group of cell sizes, capacities, chemistries, capacities, and may further differentiate conventional rechargeable cells from those rechargeable cells (e.g., of the type described above) that are able to accept a high charging current for fast charging.

In accordance with the preferred embodiment, the band 53 may comprise either or both of SS 24600 (further described in Appendix A-1) and Electrodag® PD-034 (further described in Appendix A-2), both of which are commercially available from Acheson Colloids Company, located in Port Huron, Mich. The band 53 may be constructed either as a mixture of SS 24600 and PD-034, or as a plurality of individual stacked layers (i.e., overlapping in the vertical direction) of each material. Alternatively, band 53 could comprise any other suitable coating, including the rotogravure and flexographic coatings identified in Appendix A-3. Suitable coatings and materials for coatings are further described in the following U.S. patents: U.S. Pat. No. 4,518,524 entitled “Silver Coating Composition for the Use in Electronic Applications and the Like”; and U.S. Pat. No. 5,395,876 entitled “Surface Mount Conductive Adhesives,” the disclosures of which are hereby incorporated by reference as if set forth in their entirety herein. The band 53 may furthermore be transparent or colored as desired.

If band 53 is a mixture, the ratio of the two materials will determine the resistivity of the band and the thickness of the layer will determine the overall resistance of the band 53, it being appreciated that the carbon-based SS 24600 achieves a significantly higher resistance than the silver-based PD-034. Referring also to FIG. 4, band 53 can be coated with an optional thin abrasion-resistant layer 58.

If band 53 comprises a plurality of stacked layers of SS24600 and PD-034, the thickness of each layer will determine the overall resistance of the band 53. It should be appreciated that an optional outer layer 58 may comprise silver. While silver would decrease the susceptibility of the band 53 to abrasion, the silver would also reduce the resistivity of the band 53. Accordingly, if individual layers are used, it would be preferable for the outer layer 58 to comprise a mixture of PD-034 and SS 24600, as the outer layer 58 would provide the necessary abrasion resistance while exhibiting enough electrical resistance in the longitudinal distance to force current to flow radially through the layer(s) disposed beneath the outer layer 58 given the small thicknesses of the layer 58, thereby enabling a reliable measurement of the band resistance.

The band 53 therefore may be constructed within one of several available narrow ranges of resistance levels to be specific to a given cell size, capacity, chemistry and cell type. For instance, if the two materials are mixed to provide a single composite layer, a greater amount of the higher resistivity SS 24600 as compared to the silver-based PD-034 will achieve a higher resistance at the equivalent thickness of printed material. A higher ratio of PD-034 to SS 24600 will conversely decrease the resistance. Increasing and decreasing the thickness of band 53 will also increase and decrease the resistance accordingly. Thus bands may be mass-produced having predetermined ratios and corresponding predetermined resistivities that are suitable to be printed on the labels of cells that, based on their size, capacities, chemistries and charging capabilities, are designated to correspond to a given resistance.

One skilled in the art will appreciate that a predetermined resistance of band 53 could furthermore be achieved using one or more individual layers of SS 24600 printed on top of one or more printed layers of PD-034. It is also known in the art that the thickness of an individual layer of printed may affect the obtained resistivity of the material printed and thereby the resistance of the final band. It should furthermore be appreciated that an additional protective layer (not shown) could be applied to the radially outer edge of band 53, thus creating a raised surface for added abrasion resistance while allowing the selectively resistant surface to be readily contacted for band resistance measurement. Similarly, one skilled in the art would also recognize that the abrasion resistance of the resistive coating could be usefully improved by adding less conducting abrasion resistant materials to the more conducting inks to provide coating that maintains a resistance within a useful range but has an improved resistance to abrading in use.

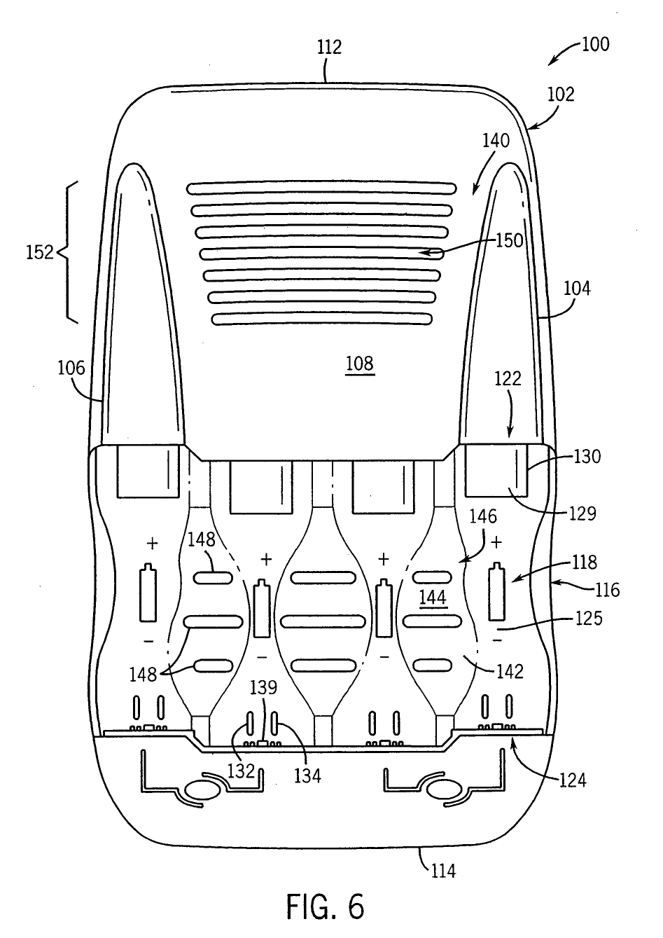

Referring now to FIGS. 5 and 6, the present invention recognizes that exposing a cell to excessive temperatures during charging contributes significantly to internal cell pressure, thereby reducing the cell's charge capacity and prematurely activating a pressure-responsive switch of the type discussed above.

An axially extending charger 100 is illustrated having a housing 102 defined by axially extending side walls 104 and 106, upper wall 108, base 110, and first and second laterally extending end walls 112 and 114, respectively. Second end wall 114 is disposed axially downstream of the first wall 112. An electrical lead (not shown) extends from housing 102 and has power supply with a standard plug that is received by an electrical receptacle to provide power to the charger 100. Alternately the power may be supplied through a 12 V adaptor commonly referred to as a cigarette lighter adaptor. Charger 100 is designed to rest on a table, on a vehicle seat, on a vehicle floor or a like flat surface, and receive power from a conventional electrical receptacle (not shown).

A void is formed in the upper wall 108 proximal the second end wall 114 that provides a battery compartment 116. The battery compartment 116 includes a plurality of axially extending grooves 118 (four grooves illustrated), each of which sized to receive a size AAA rechargeable battery 10′ configured as described above with reference to AA cell 10. Each groove 118 is defined by a first end wall 122 and a second end wall 124 disposed downstream from the first end wall, and a curved base 125 that conforms to the cylindrical outer wall of battery 10′. Specifically, the battery 10′ is inserted into a groove 118 such that the positive end interfaces with the first end wall 122 and the negative end interfaces with the second end wall 124.

A plastic or other nonconductive plug 130 extends into each groove 118 from positive end wall 122, and is spring loaded to enable the plug to adjust its axial position depending on the length of the inserted battery 10′. The plug defines a circular bore at its axially outer face that is sized to receive the nipple of the battery 10′, such that a contact 129 disposed in the bore engages the positive end 19 of the battery 10′. A plurality of charging contacts 131 extends from end wall 124 and engages the negative end 39 of cell 10′. In particular, an upper negative charging contact 131 is disposed above (and laterally between) a pair of negative charging contacts 131 so as to engage cells of varying sizes (See also FIG. 14).

The total force combined from the positive 130 and negative contacts 131 is equal to two pounds for AAA size cells, and at least 3 pounds for AA size cells, thereby, in combination with a wiping of the surface contact of the cell when the cell is installed, creating a low resistance to fast charging currents. Size AAA cell 10′ engages the lower contacts 131, as illustrated in FIG. 10. Contacts 139 and 131 are connected to electronic circuitry in the form of a microprocessor 137 that is disposed on a circuit board 135 that is disposed in charger 100. Microprocessor 137 thus determines the charge current (or voltage) to be applied to the cell 10′. While the charger 100 illustrated receiving size AAA cells, one skilled in the art appreciates that a charger could be constructed in accordance with the principles of the present invention that is compatible with AA, C, and D, N size cells, and others.

Referring now also to FIG. 14, charger 100 further includes a thermistor 139 that is connected to microprocessor 137 via leads 141. Thermistor 139 thus enables microprocessor 137 to sense the temperature of the battery 10 and surrounding environment during charging, and vary the charge applied to the cell depending on the cell type when the temperature within battery compartment 116 reaches a predetermined level. The thermistor 139 may engage the negative 39 or positive 19 end of the battery 10 directly, or alternatively be disposed anywhere in the battery compartment 116. Once the processor receiving input from the thermistor 139 determines that the temperature in the cell cavity 118 has exceeded a predetermined threshold, charging can be discontinued, depending on the cell type, and a maintenance charge between can be applied to the cell. The thermal cutoff may be used in combination with cell 10 containing the internal pressure-responsive switch 11 described above, or any alternative secondary cell such that either excessive internal cell pressure or excessive temperature will cause the charging current to be terminated.

Referring now to FIGS. 5, 6, and 8, charger 100 includes an air moving system 140 that circulates cool ambient air through battery compartment 116. Air moving system 140 enables the reduction of excessive temperatures that are typically associated with conventional cells during charging. In particular, a shelf 142 is disposed between adjacent grooves 118, and defines a substantially horizontal upper face 144. An air intake vent 146 includes a plurality of slots 148 that extend laterally through the upper face 144 of each shelf 142. Slots 148 are recessed with respect to the battery 10. An air outlet vent 150 includes a plurality of slots 152 that extend laterally through the upper wall 108 proximal end wall 112. The interior of the charger 100 is sufficiently hollow so as to provide an internal conduit between vents 146 and 150.

A forced air source 103 is disposed inside the charger 100 at any location suitable to force air disposed inside the housing 102 out of the housing via vent 150. The expulsion of air from vent 150 causes a suction that forces cool ambient air into the housing 102 via vents 146. Air thus flows along the direction of Arrow X from vents 146 and through housing 102, and exits the charger 100 at vent 150. Because each vent 146 is disposed adjacent battery 10 and recessed with respect to the battery, cooled ambient air flows around that portion of the outer circumference of the battery that is disposed outwardly with respect to vent 146. Batteries 10 are thus cooled via convection. The air moving system 140 thus prevents hot air from accumulating around the individual cells being charged, and thus extends the charge capacity of the cell. While the interior of housing 102 is sufficiently hollow to place vents 146 and 150 in fluid communication, it should be appreciated that a conduit (not shown) may be constructed inside housing 102 that has vents 146 and 150 as its outer ends. The forced air source 103 would then be disposed in the conduit to produce an air flow in the desired direction.

The air moving system and thermal cutoff system may be used either alone or in combination in the charger 100. It should be further appreciated that the forced air source 103 may be a fan disposed in the housing 102 at a location proximal vents 150, or alternatively may comprise any apparatus operable to cause air to flow between vents 146 and 150. It should furthermore be appreciated that the flow of air may be reversed, such that air is received into the housing 102 at vent 150 and exits the housing at vents 146. Furthermore, while ambient air flows past the cells in a direction generally transverse to the charger 100, the air could alternatively flow through the battery compartment 116 in a lateral direction, an axial direction, under the batteries 10, around the batteries, or alternatively vents 146 may be configured to form a swirl of air in the battery compartment 116.

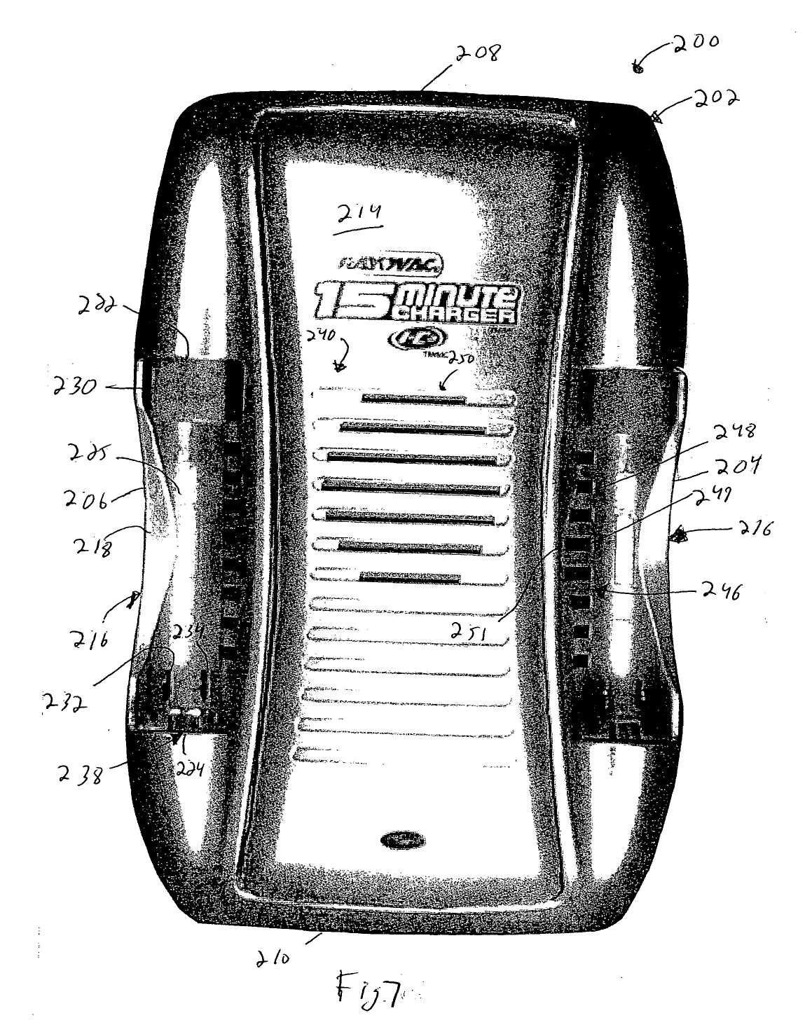

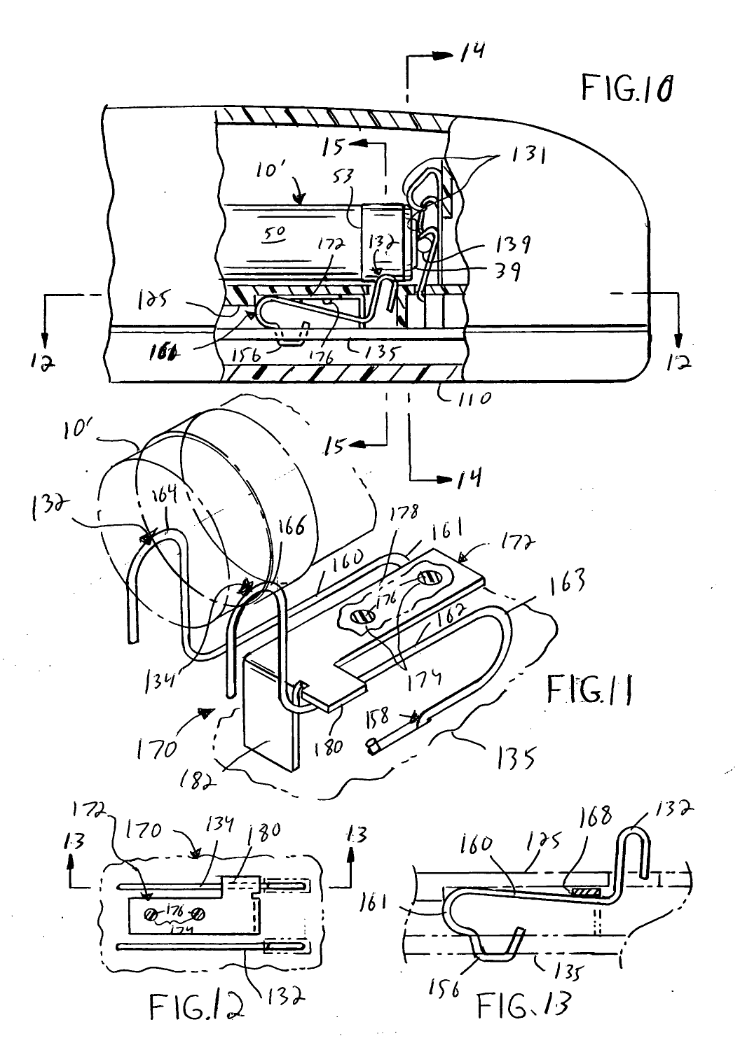

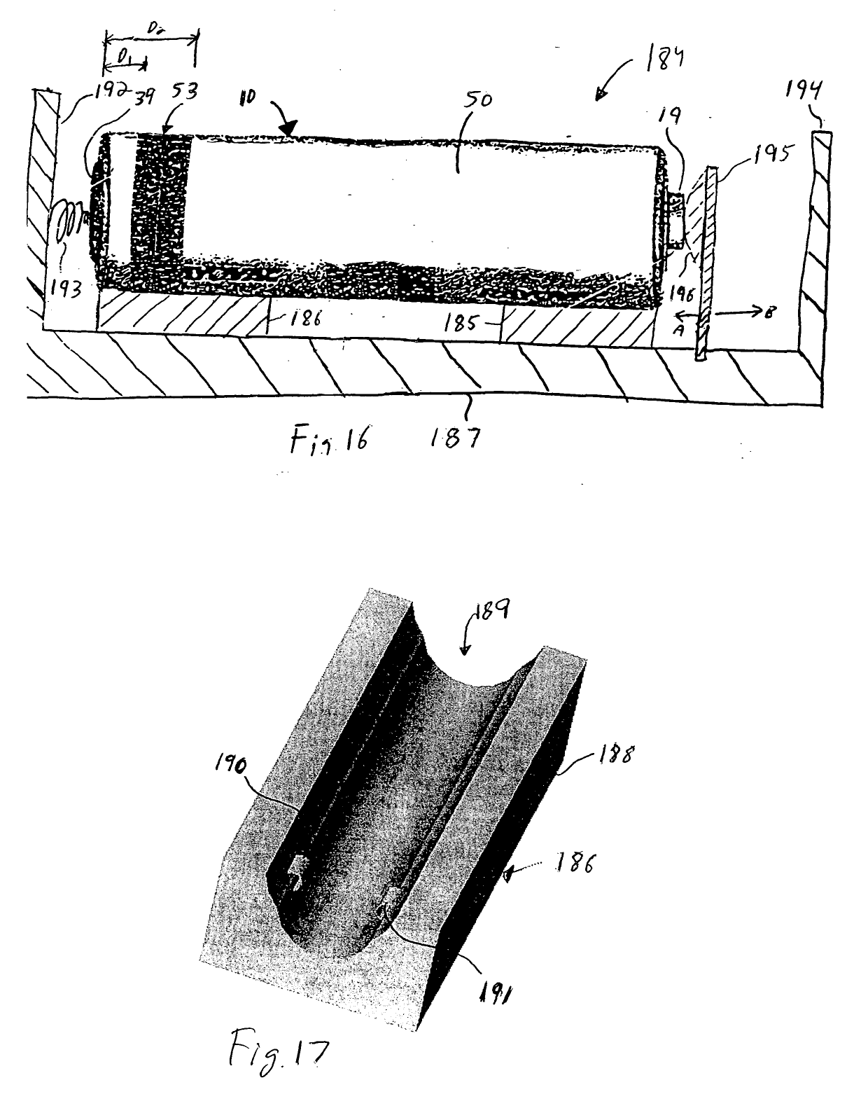

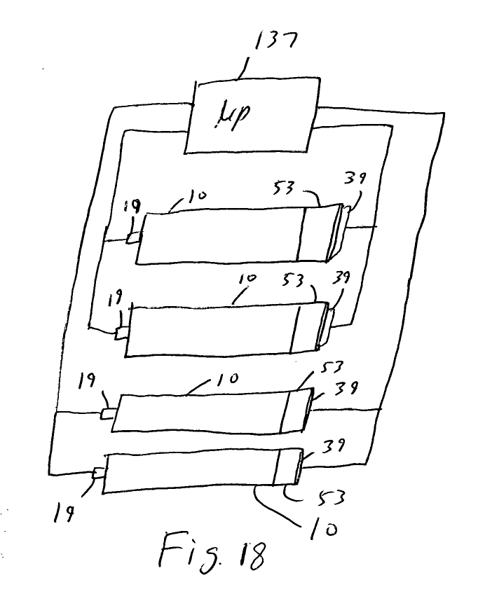

Referring now also to FIGS. 11, and 13, a pair of laterally displaced band resistance sensing contacts 132 and 134 extends upwardly from circuit board 135, through apertures 145 that extend through base 125 (see FIG. 15) and into cell compartment 116. Contacts 132 and 134 are formed from any suitably conductive material, such as Nickel, or Nickel-plated steel. Each contact 132 and 134 includes a first U-shaped end 156 and 158, respectively, that extends through, and is connected to, circuit board 135 preferably via solder. First ends 156 and 158 extend generally upwardly from circuit board 135 and are connected to arms 160 and 162, respectively, that extend generally axially towards the negative end 39 of the cell 10′, at pivot locations 161 and 163. Arms 160 and 162 are integrally connected to connected to second hook ends 164 and 166 that extend into cavity 16 at a predetermined location from negative charge contacts 131. Contacts 132 can thus pivot about locations 161 and 163 to depress hook ends 164 and 166 within cavity 16. A pair of notches 168 (one shown) extends downwardly from the lower surface of base 125 to initially bias hook ends 164 and 166 downwardly when a cell is not present in compartment 116, thereby pre-loading contacts 132 and 134 and ensuring a minimum necessary force of 100 g to bias the contacts downwardly.

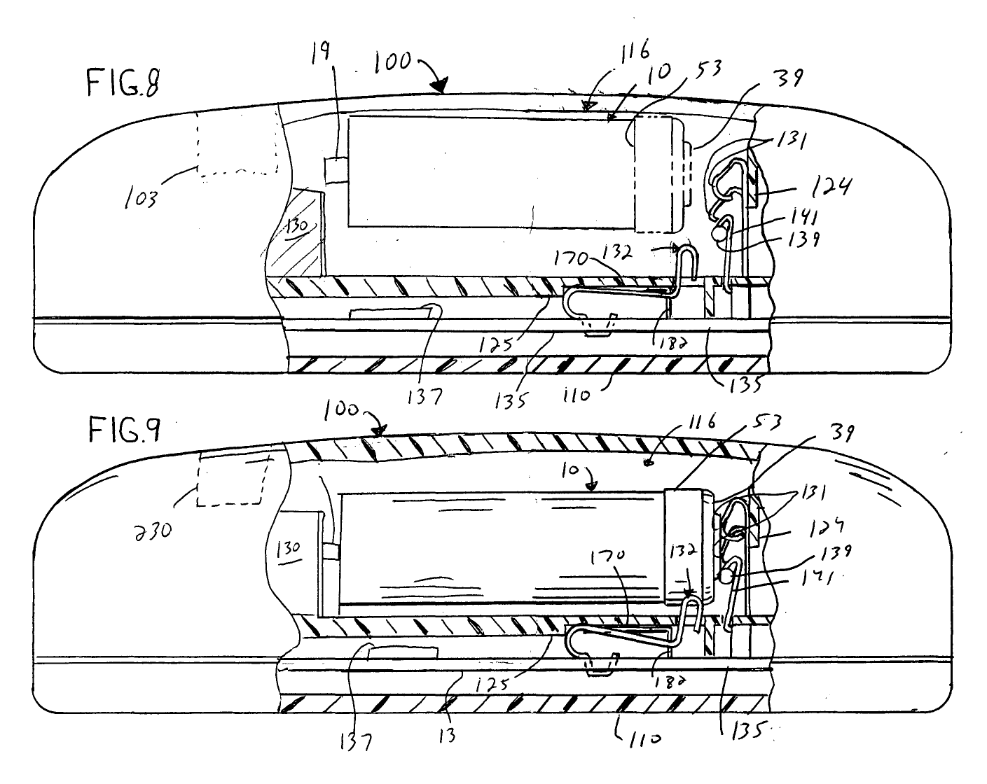

Referring now also to FIG. 12, a battery presence detecting switch 170 includes a metal plate 172 that is secured against the bottom surface of wall 125 in vertical alignment with contact 134. Plate 172 includes a longitudinally extending wall 178 connected to a laterally extending flange 180 at the positive-most end of wall 178. The outer longitudinal end of flange 180 is integrally connected to a vertically extending flange 182. Flange 182 extends to circuit board 135, and is in electrical communication with microprocessor 137. A pair of apertures 174 extends through surface 178 and receives corresponding pair of locking pins 176 that extends downwardly from base 125 to lock the plate 172 in position.

Referring also now to FIG. 8, when cell 10 is not installed in compartment 116, contact 134 is biased towards an upper position whereby arm 162 is in contact with flange 180. Accordingly, a circuit formed by microprocessor 137, circuit board 135, contact 134, and plate 172 is closed, thereby enabling the microprocessor to conclude that a cell is not properly installed in the compartment 116. Referring now to FIG. 9, once cell 10 is installed in the compartment 116, band 53 biases contacts 132 and 134 downwardly, thereby removing arm 162 from contact with flange 180 and opening switch 170. Microprocessor 137 thus determines that a cell is installed and initiates a charging routine, as will be described in more detail below.

It should be appreciated that the cell 10 installed in charger 100 in FIG. 9 is a size AA cell, while the cell 10′ installed into the charger 100 as illustrated in FIGS. 10 and 15 is a size AAA cell. As illustrated, the size AA cell 10 is vertically offset from base 125 a greater distance than AAA cell 10′ and engages the upper pair of charge contacts 131, while AAA cell 10′ engages the lower charge contact 131. Nevertheless, because contacts 134 and 136 protrude into compartment 116 a greater distance than the offset between AA cell 10 and base 125, switch 170 opens, and the resistance of band 53 can be measured. Furthermore, because band 53 is positioned relative to the negative terminal end 39 of the cell, and because hook ends 164 and 166 are positioned relative to the negative contacts 131, hook ends 164 are aligned with band 53 regardless of cell size. It should thus be appreciated a skilled artisan that charger 100 could be configured to accept any size cell without departing from the principles of the present invention.

The present invention recognizes that the cell compartment 116 described above with reference to charger 100 is only one of numerous cell compartment configurations available in accordance with the present invention. Accordingly, FIGS. 16-17 illustrates a cell compartment 184 constructed in accordance with an alternate embodiment.

In particular, a size AA battery 10 is placed in the battery compartment 184 that is configured to receive multiple batteries having various sizes. Compartment 184 includes a first wall 192 that extends vertically from the base 187 of charger compartment 184 and has a negative spring-loaded contact 193 for engaging the negative terminal end 39 of battery 10. A second wall 194 extends vertically from the opposite side of base 187 and, along with wall 192, defines battery compartment 184. A slidable wall 195 is disposed within compartment 184 and has a positive contact 196 extending inwardly therefrom for engaging the positive terminal end 19 of battery 10. Compartment 184 is thus able to deliver a charging current to battery 10. It should be appreciated that the charger may supply either a constant voltage or constant current charge, and that high current levels may be used when charging a fast charging cell such as cell 10.

In order to accommodate batteries having various sizes, wall 42 is slideable along a guide rail (not shown) in the direction of arrows A and B to accommodate batteries having reduced and greater lengths, respectively.

A pair of cradles 185 and 186 is supports the positive and negative ends 19 and 39 such that the middle portion of the battery is suspended with respect to the base 187 of compartment 184. This design enables air to flow past the battery during charging, thereby more quickly cooling the cell and, as a result, more rapidly and completely charging the cell.

Cradle 186 may be made of any suitable and preferably nonconductive material, and comprises a housing 188 having a generally semi or partially cylindrical groove 189 extending axially therein. Cradle 186 is mounted onto the base 187 or elsewhere in the compartment 184 so as to be disposed proximal the negative end 39 of a battery 10 when inserted into compartment. A similar cradle 185 is disposed within compartment 184 at a location so as to support the positive end 19 of battery 10.

A pair of resistance sensing contacts 190 and 191 extend inwardly from cradle 186 and are axially aligned with the contact band 53 and radially offset from one another to engage the band at different locations, thereby enabling a resistance measurement at a predetermined location. The contacts are additionally spring-mounted to the cradle 186 in the manner described above with reference to charger 100 so as to engage the contact band 53 regardless of the size or radial orientation of the battery within compartment 184. Contacts 190 and 191 are further electrically connected to control circuitry or a microprocessor or the like (not shown) that is preferably disposed in the charger as described above. Alternatively, it should be appreciated that the control circuitry could be external with respect to the charger. Compartment 184 could also include a battery presence detection switch of the type described above with reference to charger 100.

Band 53 extends axially between distances D1 and D2 from the negative terminal 39, and extends radially around the entire circumference of the battery 10. Contacts 190 and 191 are displaced a predetermined distance from wall 192 so as to be disposed between D1 and D2 and therefore aligned with band 53 with sufficient clearance on either side of the contacts. Because the placement and size of the band 53 is based on the distance from the negative end 39 of the cell 10, the band 53 will be aligned with contacts 190 and 191 regardless of the size of the battery 10. The charger will thus reliably identify the presence of a battery having the conductive band 53.

The present invention further anticipates that positive contact 24 could alternatively be slide-able, and the band 28 and contacts 46 and 48 be positioned at a predetermined distance from wall 38. The charger is also configured to accept the terminal ends of a 9-volt battery and has contacts (not shown) to engage a band that surrounds the outer periphery of the cell, as would be appreciated by those having ordinary skill in the art.

Referring now to FIG. 7, a charger 200 is constructed in accordance with an alternate embodiment and is illustrated having reference numerals corresponding to like elements of the charger 100 incremented by 100, unless otherwise stated, for the purposes of clarity and convenience. In particular, a vertically extending charger 200 is illustrated having a housing 202 defined by vertically extending side walls 204 and 206, horizontally extending upper and lower end walls 208 and 210, respectively, vertically extending rear wall (not shown), and vertically extending front wall 214. A standard electrical plug (not shown) extends transversely outwardly from the housing 202 that is received by a conventional electrical receptacle. Charger 200 is thus configured to be wall-mounted such that the rear wall faces the mounting surface, and front wall 214 extends transversely outwardly from the wall during use.

A pair of vertically extending voids is formed in the front wall 214 at a location proximal side walls 204 and 206 that provides a corresponding pair of battery compartments 216. Each battery compartment 216 includes a vertically extending groove 218 that is sized to receive a rechargeable battery. Each groove 218 is defined by a first positive end wall 222 and a second negative end wall 224, and a curved base 225 that is shaped to conform to the cylindrical outer wall of the battery.

A plastic or other nonconductive plug 230 extends into each groove 218 from positive end wall 222 as described above with reference to charger 100. A first and second contact 232 and 234, respectively, extend upwardly from the base 225 proximal the negative end wall 224 for sensing and measuring the resistance of a conductive band as described above. A plurality of contacts 238 extends into each groove 218 from the negative end wall 224 in the manner described above for sensing the open circuit voltage and applying a charge current to the battery. The charger 200 further includes a thermal cutoff system including a thermistor that is positioned as described above.

In order to reduce the excessive temperatures that are typically associated with cells during charging, charger 200 includes an air moving system 240 that circulates cool ambient air through battery compartment 216. In particular, an air intake vent 246 is disposed in each compartment 216, and includes a plurality of horizontal slots 248 that extend through base 225. Slots 248 are vertically stacked, and extend substantially along the entire length of the groove 218. A portion of each slot 248 is disposed beneath the battery, and a portion of each slot is disposed adjacent the battery. Slots 248 define a first end 249 that faces a outwardly direction transverse to the charger 200, and a second end 251 that faces a direction generally parallel to the direction of upper and lower walls 208 and 210. An air outlet vent 250 includes a plurality of slots 252 that extend horizontally through the front wall 214 of the charger 200. The interior of charger 200 is sufficiently hollow so as to provide an internal conduit between vents 246 and 250.

A forced air source 203 is disposed inside the charger 200 at any location suitable to force air disposed inside the housing 202 out of the housing via vent 250. The expulsion of air from vent 250 causes a suction that forces cool ambient air into the housing 202 via vents 246. Vents 246 are positioned to force ambient air to flow around the circumference of each cell. Air thus flows from vents 246 and through housing 202, and exits the charger 200 at vent 250. Because vents 246 are disposed adjacent the batteries, the batteries are cooled via convection. The air moving system 240 thus prevents hot air from accumulating around the individual cells being charged, and thus extends the charge capacity of the cell. Charger 200 may alternatively be constructed in accordance with all of the alternatives discussed above with reference to charger 100.

Referring now to FIG. 18, four size AA cells 10 are schematically illustrated as being installed in charger 100. In particular, cells 10 are divided into groups 177 of two cells connected in parallel. Each group 177 is connected to the microprocessor. It should thus be appreciated that charger 200 would connect only one group of two cells in parallel. Accordingly, if one cell 10 is fully charged (or pressure-responsive switch 11 begins iteratively opening and closing), the cell 10 connected in parallel will continue to receive at least as much, if not more current, to continue charging as will be described in more detail below. Alternatively, if both cell 10 including switch 11 (fast charging cell) and a cell that does not include a pressure dissipation mechanism (slow charging cell) are connected in parallel, microprocessor 137 would apply a slow charging rate current to avoid damaging the slow charging cell. It should be appreciated that the cells 10 could alternatively be connected in series, in which case a switch (not shown) would be associated with each battery compartment 116 that would allow the charging current to bypass the compartment 116 either when the corresponding cell fully charged, or if the compartment is not occupied by a cell.

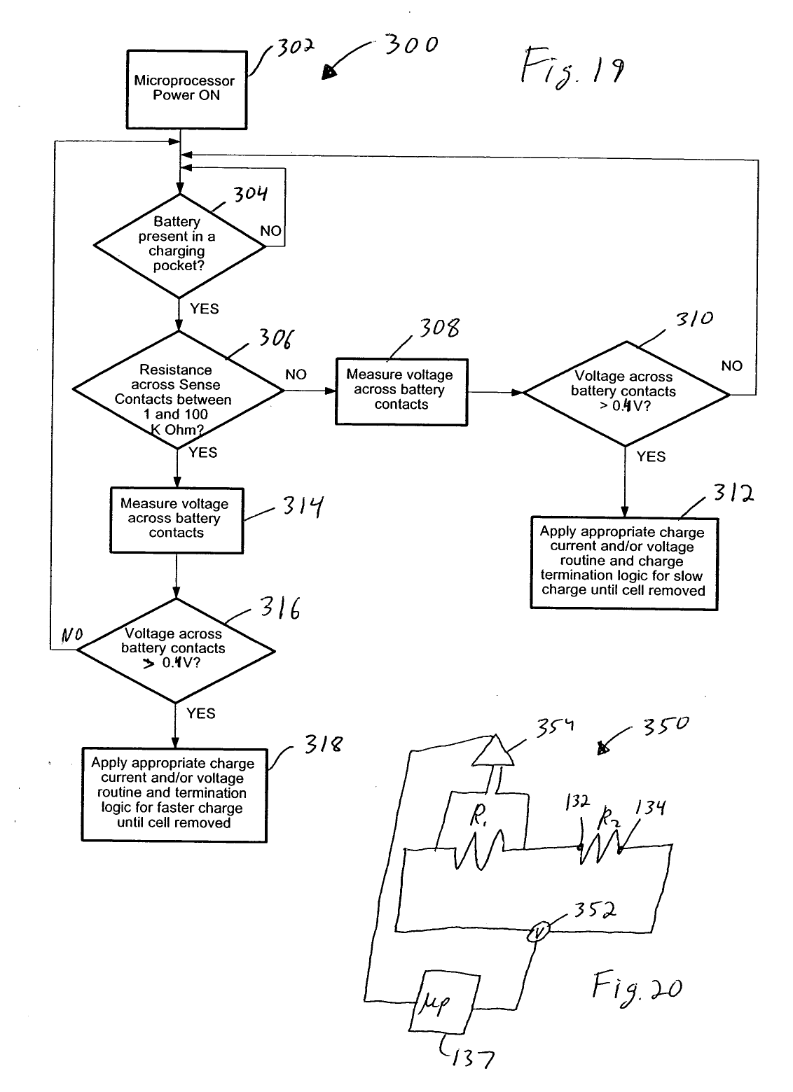

Referring now to FIG. 19, the cell differentiation and charging routine 300 will now be described with reference to charger 100, it being appreciated that routine 300 could be equally applicable to any of the chargers described herein or equivalents thereof that are compatible with the present invention. Routine 300 begins at step 302, whereby microprocessor 137 is powered on by connecting the charger to a standard electrical receptable and optionally activating a power switch (not shown). At decision block 302, microprocessor 137 determines, based on the status of switch 170, whether a battery is disposed in a charging compartment 116. If a battery is not found in the compartment 116, routine 300 continues to run decision block 304 until a battery has been installed, thereby closing the corresponding switch 170. It should thus be appreciated microprocessor 137 runs routine 300 continuously for each compartment 116 in the charger 100.

Once a battery has been detected in compartment 116, microprocessor determines the resistance across resistance sensing contacts 132 and 134, which is positioned to sense band 53 if it is disposed on the cell that installed in compartment 116. In particular, referring now also to FIG. 20, a voltage divider circuit 350 is provided, and includes a first resistor R1 disposed on circuit board 135 that is connected in series to contacts 132 and 134. Contacts 132 and 134 provide a second resistance R2 equal to the resistance of the cell across the location between the contacts. Resistors R1 and R2 are connected in series to a voltage source 352, which is preferably a constant voltage, provided by microprocessor 137.

An analog-to-digital converter 354 is connected to either side of resistor R1, and the voltage across R1 (V1) is sensed by microprocessor 137 via ADC 354. Based on the sensed Voltage V1, and known voltage V that was applied to circuit 350, V2 (voltage across resistor R2) is calculated as the difference of V and V1. Once V1, R1, and V2 are known, the resistance R2 can be solved for using conventional voltage divider techniques, i.e., V1/R1=V2/R2. Microprocessor is thus able to solve for the resistance across resistance sensing contacts 132 and 134.

Referring again to FIG. 19, microprocessor 137 determines at decision block 137 whether the sensed resistance R2 is within a predetermined range, which is between 1 kilo-Ohm and 100 kilo-Ohms in accordance with the preferred embodiment. It should be appreciated that the predetermined range can alternatively be 1-50 kΩ, and alternatively still 1-250 kΩ. It is appreciated that conventional labels such as label 50 have a resistance of 500 kilo-Ohms and greater. Accordingly, band 53 is manufactured to have a resistance less than 100 kilo-Ohms to ensure that a conventional label is not mistaken for band 53. The resistance of band 53 is further maintained above 1 kilo-Ohm to ensure that a bare metal can such as can 12 is not mistaken for band 53. In this regard, it should be appreciated that band 53 is easily distinguishable from other components residing in or on conventional secondary cells.

If the resistance sensed by contacts 132 and 134 is not within the predetermined range as determined at decision block 306, routine 300 advances to step 308, whereby the voltage across the positive and negative terminals of the battery is measured. At decision block 310, microprocessor 137 determines whether the measured voltage is above a nominal value (0.4V in accordance with the preferred embodiment), thereby indicating a potentially functional cell. If the measured voltage is less than the predetermined nominal value, microprocessor 137 determines that the cell is not functional and reverts to step 304 without applying a charge to the cell. Charger 100 could also provide an indicator alerting the user that the cell is not chargeable.

If the voltage across the cell is greater than 0.4 V as determined at decision block 310, microprocessor 137 applies a charge at step 312 that is deemed appropriate for either a secondary cell that does not have an in-cell pressure dissipation system, such as switch 11, and/or a primary cell that has been mistakenly placed in charger 100. It has been determined that a charging current greater than 4 Amps applied to a cell will result in rapid pressure accumulation in conventional secondary cells. Accordingly, charger 100 applies a constant current charge to the cell less than 4 Amp, and more preferably below 0.5 Amp, as the cell disposed in compartment 116 might not be a secondary cell. The charge continues indefinitely until the cell is removed from the charger. Alternatively, if the sensed label resistance is less than 1 kΩ, microprocessor 137 could apply no charge to the cell based on the possibility that a bare can is being sensed.

If, on the other hand, the sensed contact resistance is within the predetermined range as determined at decision block 306, microprocessor 317 determines that cell 10 is present having an increased charge capacity over conventional secondary cells. Accordingly, the voltage across terminal ends 19 and 39 is measured at step 314, and microprocessor 317 verifies that the measured voltage is greater than 0.4 V at decision block 316, as described above with reference to decision block 310. If not, microprocessor 317 concludes that the cell 10 is not chargeable, and reverts to step 304.

If the cell voltage is greater than the nominal threshold, microprocessor 317 applies what is described herein as a “fast” charge, relative to conventional secondary cell charges, to cell 10 at step 318. The fast charge includes a constant voltage charge within the range of 1.2 and 2 V, and more preferably within the range of 1.5 and 1.7 V. The applied current is limited to a value between 4 and 15 Amps. The constant voltage charge is applied until the earlier of 1) the switch 11 opening, and 2) the expiration of fifteen minutes from charge initiation. Microprocessor 137 senses the switch opening by monitoring the amount of current applied to cell 10 during a constant voltage charge. If, for example, the charge current level falls below a predetermined value of 2 Amps, microprocessor 137 concludes that the cell has opened.

In this regard, with reference again to FIG. 18, it should be appreciated that, when cells 10 are charged in parallel, the current will only fall to the predetermined value if both switches open. Charging will therefore not terminate until either both switches are open, or fifteen minutes have expired. However, when the switch 11 of one cell 10 is open while the switch 11 of the other cell 10 is closed, it should be appreciated that the closed cell will only accept a current level up to the cell capacity even though additional current may be available for that cell.

Once the fast charge has been completed, microprocessor 137 activates an indicator alerting the user that the battery is ready for use. If the cell is not removed, microprocessor 137 then applies what is known as a “trickle” charge less than 500 mili-Amps (and preferably 270 mili-Amps) constant current to the cell for the remainder of one hour from charge initiation. After the expiration of an hour, microprocessor 137 applies a maintenance charge of less than 100 mili-Amps, and preferable 64 mili-Amps. The maintenance charge continues indefinitely until the cell is removed. It should be appreciated that charger 100 may include indicators corresponding to the type of charge being applied.

While the present invention has been described with reference to stand-alone chargers, it should be appreciated that the present invention may be implemented in battery compartments of electronic devices, such as digital cameras, digital video cameras, cassette players, compact disc players, cellular phones, and the like. Each fast-charging cell 10 would be identified by a band 53 of the type described above. The electronic device would thus determine, based on a sensed resistance at a predetermined location on the cells, whether the cells can accept a high current charge, a low current charge, or no current charge, as described above. Accordingly, when the device is to be charged by placing the device in a charger, the device would communicate various cell characteristics to the charger, including the charge type to be applied to the cells, based on the sensed resistance as described above.

The invention has been described in connection with what are presently considered to be the most practical and preferred embodiments. However, the present invention has been presented by way of illustration and is not intended to be limited to the disclosed embodiments. Accordingly, those skilled in the art will realize that the invention is intended to encompass all modifications and alternative arrangements included within the spirit and scope of the invention, as set forth by the appended claims.

We claim:

1. A secondary electrochemical cell capable of receiving a predetermined charge rate, comprising:
positive and negative terminals connected to a cathode and anode, respectively, for delivering power;
a can defining the positive and negative terminals and containing the cathode and anode; and
a label surrounding an outer periphery of the can having a first resistance; and
a band made from an ink that is printed onto the label at a predetermined location, wherein the band has a resistance within a predetermined range.

2. The cell as recited in claim 1, wherein the band has a second resistance less than the first resistance.

3. The cell as recited in claim 2, wherein the second resistance is between 1 kΩ and 100 kΩ.

4. The cell as recited in claim 3, wherein the first resistance is greater than 500 kΩ.

5. The cell as recited in claim 1, further comprising a switch that opens the connection between the positive electrode and the positive terminal when an internal cell pressure exceeds a predetermined level.

6. The cell as recited in claim 1, further comprising an abrasion-resistant layer surrounding the band.

7. The cell as recited in claim 1, wherein the band is printed using a conductive ink.

8. The cell as recited in claim 1, wherein the band is printed using a conductive carbon ink.

9. The cell as recited in claim 1, wherein the band is from the group consisting of PD-34 and SS24600.

10. The cell as recited in claim 8, wherein the band comprises a layer having mixed conductive carbon inks.

11. The cell as recited in claim 2, wherein the second resistance is between 1 kΩ and 250 kΩ.

12. The cell as recited in claim 9, wherein the band comprises a layer having mixed PD-34 and SS24600.

13. The cell as recited in claim 7, wherein the band comprises separate stacked layers of conductive inks.

14. The cell as recited in claim 8, wherein the band comprises separate stacked layers of conductive carbon inks.

15. The cell as recited in claim 7, wherein the band comprises separate stacked layers of PD-34 and SS24600.

16. The cell as recited in claim 1, further comprising one of a NiMH cell, an alkaline cell, a Lithium Ion cell, and a lead acid cell.

17. The cell as recited in claim 1, wherein the band is disposed proximal the negative end of the cell.

18. A secondary electrochemical cell capable of receiving a predetermined charge rate, comprising:
positive and negative terminals connected to a cathode and anode, respectively, for delivering power;
a can defining the positive and negative terminals and containing the cathode and anode; and
a label surrounding an outer periphery of the can having a first resistance, wherein the label includes a band disposed at a predetermined location on the band, wherein the band has a second resistance between 1 kΩ and 100 kΩ.

19. The cell as recited in claim 18, wherein the first resistance is greater than 500 kΩ.

20. The cell as recited in claim 18, further comprising a switch that opens the connection between the positive electrode and the positive terminal when an internal cell pressure exceeds a predetermined level.

21. The cell as recited in claim 16, further comprising an abrasion-resistant layer surrounding the band.

22. The cell as recited in claim 18, wherein the band is printed using a conductive ink.

23. The cell as recited in claim 18, wherein the band is printed using a conductive carbon ink.

24. The cell as recited in claim 18, wherein the band is from the group consisting of PD-34 and SS24600.

25. The cell as recited in claim 18, wherein the band comprises a layer having mixed conductive inks.

26. The cell as recited in claim 18, wherein the band comprises a layer having mixed conductive carbon inks.

27. The cell as recited in claim 18, wherein the band comprises a layer having mixed PD-34 and SS24600.

28. The cell as recited in claim 18, wherein the band comprises separate stacked layers of conductive inks.

29. The cell as recited in claim 18, wherein the band comprises separate stacked layers of conductive carbon inks.

30. The cell as recited in claim 18, wherein the band comprises separate stacked layers of PD-34 and SS24600.

31. The cell as recited in claim 18, further comprising one of a NiMH cell, an alkaline cell, a Lithium Ion cell, and a lead acid cell.

32. The cell as recited in claim 18, wherein the band is disposed proximal the negative end of the cell.

33. The cell as recited in claim 18, wherein the band surrounds the label.

34. A secondary electrochemical cell capable of receiving a predetermined charge rate, comprising:
positive and negative terminals connected to a cathode and anode, respectively, for delivering power;
a can defining the positive and negative terminals and containing the cathode and anode; and
a label surrounding an outer periphery of the can having a first resistance, wherein the label includes a band disposed on the label at a predetermined location, and wherein the band has a resistance within a predetermined range that identifies the cell as containing an internal pressure-responsive switch that terminates the connection between the positive terminal and the positive electrode when an internal cell pressure level exceeds a predetermined threshold.

35. The cell as recited in claim 34, configured to receive a charge current greater than 4 Amps.

36. The cell as recited in claim 34, further comprising an abrasion-resistant layer surrounding the band.

37. The cell as recited in claim 34, wherein the band is selected from the group consisting of PD-34 and SS24600.

38. The cell as recited in claim 37, wherein the band comprises a layer having mixed PD-34 and SS24600.

39. The cell as recited in claim 37, wherein the band comprises separate stacked layers of PD-34 and SS24600.

40. The cell as recited in claim 39, further comprising one of a NiMH cell, an alkaline cell, a Lithium Ion cell, and a lead acid cell.

41. The cell as recited in claim 34, wherein the band is disposed proximal the negative end of the cell.

42. A secondary cell charging apparatus that discriminates between properties of electrochemical cells, the charger comprising;
at least one cell cavity containing positive and negative charging contacts configured to engage a corresponding positive and negative contact of an electrochemical cell;
a pair of adjacent depressable resistance sensing contacts having first ends connected to electronic circuitry and second ends extending into the cell cavity at a predetermined location for engaging an outer surface of the electrochemical cell; and
wherein the electronic circuitry delivers a charge to the electrochemical cell based on a sensed resistance between the sensing contacts.

43. The charging apparatus as recited in claim 42, wherein the electronic circuitry applies a charge to the electrochemical cell at a rate that is determined by a resistance measured across the resistance sensing contacts.

44. The charging apparatus as recited in claim 43, wherein the electronic circuitry applies a charge between 4 and 15 Amps when the sensed resistance corresponds to a secondary cell having internal pressure-abating mechanism.

45. The charging apparatus as recited in claim 42, further comprising a thermistor located in the cell cavity for measuring a cell cavity temperature.

46. The charging apparatus as recited in claim 42, further comprising an air mover for delivering ambient air to the cell cavity.

47. The charging apparatus as recited in claim 42, wherein the electronic circuitry applies a constant current charge to the electrochemical cell.

48. The charging apparatus as recited in claim 42, wherein the electronic circuitry applies a constant voltage charge to the electrochemical cell.

49. The charging apparatus as recited in claim 48, wherein the charge is terminated when the sensed charging current falls below a predetermined threshold.

50. A secondary electrochemical cell charging system comprising:
a charging apparatus including 1) at least one cell cavity containing positive and negative charging contacts, and 2) a pair of adjacent resistance sensing contacts having first ends connected to electronic circuitry and second ends extending into the cell cavity at a predetermined location;
a secondary cell disposed in the cell cavity, wherein the cell includes 1) positive and negative terminals connected to a cathode and anode, respectively, for delivering power, 2) a can defining the positive and negative terminals and containing the cathode and anode, 3) a label surrounding an outer periphery of the can having a first resistance, and 4) a band made from an ink that is printed onto the label at a predetermined location that is engaged by the resistance sensing contacts, wherein the band has a predetermined resistance, and wherein the cell is disposed in the charging cavity such that the positive and negative terminals engage the corresponding positive and negative charge contacts;
wherein the electronic circuitry applies a charge to the cell based on the resistance sensed between the resistance sensing contacts.

51. The charging system as recited in claim 50, wherein the cell further comprises a switch that disconnects the cathode from the positive terminal when internal cell pressure exceeds a predetermined threshold.

52. The charging system as recited in claim 51, wherein the charger applies a charge between 4 and 15 Amps to the cell.

53. The charging system as recited in claim 50, wherein the charger applies a charge to the cell between 4 and 15 Amps when the sensed resistance is between 1 kΩ and 100 kΩ.

54. The charging system as recited in claim 50, wherein the charger applies a charge to the cell less than 4 Amps when the sensed resistance is greater than 50 kΩ.

55. The charging system as recited in claim 50, wherein the charger applies a charge to the cell less than 4 Amps when the sensed resistance is greater than 100 kΩ.

56. The charging system as recited in claim 50, wherein the charger applies a charge to the cell less than 4 Amps when the sensed resistance is greater than 250 kΩ.

57. The charging system as recited in claim 50, wherein the charger applies a charge to the cell less than 4 Amps when the sensed resistance is less than 1 kΩ.

58. The charging system as recited in claim 50, wherein the charger applies no charge to the cell when the sensed resistance is less than 1 kΩ.

59. The charging system as recited in claim 50, wherein the resistance sensing contacts are depressed with a force of at least 100 g when the cell is installed into the cavity.

60. The charging system as recited in claim 50, wherein the electronic circuitry applies a constant current charge to the cell.

61. The charging system as recited in claim 50, wherein the electronic circuitry applies a constant voltage charge to the cell.

62. The charging system as recited in claim 50, wherein multiple cells disposed in corresponding cell cavities are connected in parallel.

63. A method for discriminating between cell types at a secondary cell charger of the type including 1) a cell cavity, 2) electronic circuitry, 3) positive and negative charge contacts, and 4) resistance sensing contacts extending into the cell cavity and in electrical communication with the electronic circuitry, the steps comprising:
(A) inserting an electrochemical cell into the cell cavity such that the resistance sensing contacts engage an outer cell surface at a predetermined location;
(B) measuring a resistance across the resistance sensing contacts;
(C) determining whether the resistance is within the range of 1 and 100 kΩ;
(D) if the measured resistance is within the range of 1 and 100 kΩ, apply a first predetermined charge to the cell.

64. The method as recited in claim 63, further comprising the step of measuring a voltage across positive and negative cell terminals, and applying the charge of step (D) only if the measured voltage is greater than a nominal value.

65. The method as recited in claim 64, wherein the cell includes a pressure responsive switch that terminates contact between a cell cathode and a cell positive terminal, and wherein step (D) further comprises applying the first predetermined charge until the switch terminates contact or a predetermined length of time has elapsed.

66. The method as recited in claim 65, wherein the predetermined length of time is fifteen minutes.

67. The method as recited in claim 65, wherein a second predetermined charge is applied to the cell after the first predetermined charge is completed.

68. The method as recited in claim 67, wherein the second predetermined charge is less than 500 mAmps.

69. The method as recited in claim 67, wherein the second predetermined charge is applied for a predetermined length of time.

70. The method as recited in claim 69, wherein a third predetermined charge is applied to the cell after the second predetermined charge is completed.

71. The method as recited in claim 70, wherein the third predetermined charge is less than 100 mAmps.

72. The method as recited in claim 63, wherein the sensed resistance is not in the range of 1 and 100 kΩ, further comprising the step of determining whether a voltage across cell positive and negative terminals is greater than a nominal value.

73. The method as recited in claim 72, wherein no charge is applied to the cell if the voltage is not greater than the nominal value.

74. The method as recited in claim 72, further comprising applying a charge less than 4 Amps to the cell if the voltage is greater than the nominal value.

76. The method as recited in claim 63, wherein the charger further includes a battery presence circuit that is opened when the cell is inserted into the cavity, the method further comprising detecting the presence of the cell prior to step (B).

77. A method for discriminating between cell types at a secondary cell charger of the type including 1) a cell cavity, 2) electronic circuitry, 3) positive and negative charge contacts, and 4) resistance sensing contacts extending into the cell cavity and in electrical communication with the electronic circuitry, the steps comprising:
(A) inserting an electrochemical cell into the cell cavity such that the resistance sensing contacts engage an outer cell surface at a predetermined location;
(B) measuring a resistance across the resistance sensing contacts;
(C) determining whether the resistance is within a predetermined range;
(D) If the resistance is within the predetermined range, apply a charge to the cell within the range of 4 and 15 Amps.
